(19) United States
(12) Patent Application Publication
(10) Pub. No.: US 2015/0052192 A1
(43) Pub. Date: Feb. 19, 2015

(54) DATA SERVER

(71) Applicant: A VIASYS LIMITED, Coventry Warwickshire (GB)

(72) Inventor: Sailesh Chauhan, Coventry Warwickshire (GB)

(21) Appl. No.: 14/388,681

(22) PCT Filed: Mar. 26, 2013
(86) PCT No.: PCT/GB2013/050783

§ 371 Date: Sep. 26, 2014

(30) Foreign Application Priority Data
Mar. 26, 2012 (GB) 1205222.1

(51) Int. Cl. H04L 29/08; H04L 29/06

(52) U.S. Cl. CPC H04L 67/2852; H04L 67/42; H04L 67/1095
USPC 709/203

(57) ABSTRACT

A data access point comprising: a casing containing a router configured to allow a first user to access the data access point; an integrated web domain server configured with a full content management system containing dynamic web content to be accessed by the first user; wherein the integrated server does not require a continuous connection to the internet to provide content to the user; and wherein the data access point further comprises a internet connectivity point, such as wireless LAN or 3 or 4G point, configured to access the internet and to periodically synchronise some or all of the content of integrated dynamic server with an external server. Wherein the server can be configured to allow the domain server that is integrated with the static IP cellular modem to enable access from the internet using a web domain address and a normal internet browser. This also allows remote VPN connectivity to allow maintenance and trouble shooting.

### TECHNICAL FIELD

The present invention relates to apparatus to wireless access points, web domain servers, and cellular connectivity and Captive Portals. In particular the invention relates to a network router capable of serving multiple IP addresses to users, which provides a captive portal that serves the home page on the Web Server to wireless devices connected to the apparatus.

### BACKGROUND TO THE INVENTION

It is known to connect to the internet through access points known as hotspots. In a hotspot a router provides access to the internet through a link to an internet service provider. Such hotspots may be found in public and private places, and may allow the user to fully access the internet. Alternatively, hotspots may be controlled through the use of hotspot management software which limits the websites a user can access via the router. This can be used to prevent a user from accessing an undesirable website, or restrict their access to the interne/world wide web without paying.

Such hotspot systems require a connection to an internet service provider in order to access the internet. Users will access the wireless connection and access the internet through the router.

Hotspots are typically found in static locations such as shops, offices etc., though they may be found in moving locations such as trains. In train based Wi-Fi systems the train may have a router which connects via mobile telecommunications (such as 3G, UMTS etc.) to internet service providers. Such systems therefore require significant infrastructure to allow the user to access the web. Firstly, the train must be equipped with the appropriate equipment to allow passengers to log-on and furthermore the train must communicate with 3G cell towers/base transmission stations along the route of the train. If the train loses contact with a cell tower then all connections to the internet are lost.

It is known for the server in the hotspot to contain a small, (typically 256 Mb), cache of HTML documents of webpages. This allows a user to view certain webpages even when the connection is lost and minimise load on the server and disruptions in the event that connection is lost. However, the user is only able to view the html documents and cannot access any of the functionality which may be available with a full web server. Even in the event that a file server is used such servers only allow for limited functionality associated with providing a web page. They do not allow for any functionality beyond mere providing of a page of static HTML content where dynamic back end processing is not possible.

It is also known to provide a user with a captive portal when logging-in on an access point. Such captive portals are designed for use with internet connections, and present an authentication page on a client device before access is granted. If an internet connection is not available the captive portal authentication is found not to work and the user only has an option to close the Captive portal window.

In order to overcome some of the problems associated with the above mentioned systems there is provided a data access point such as an integrated server access point for enabling access to web content without an Internet connection comprising: a casing containing the integrated components of a: router configured to allow a first user device to access the web content; an integrated dynamic server configured to store the web content to be accessed by the first user; an Internet connectivity point, such as a cellular connection, configured to access the Internet; wherein the integrated server access point is configured to enable access to web content by the user device without requiring a connection to the Internet; and is further configured to intermittently synchronise some or all of the content of integrated dynamic server with an external web server or database.

The invention provides a fully integrated wireless web server that offers full domain web server capabilities in a moving/mobile environment (e.g. on an airplane, bus, ship etc.), and enables dynamic web content to be accessed by personal mobile device users using their own built in browsers which are connected via the integrated wireless access point and Captive portal network router. As the invention provides a full web domain server with a static IP assigned to the integrated cellular modem, it enables normal internet users to access the full web domain that may be hosted within a mobile environment. Dynamic web servers therefore allow for the content provided to change according to the user's actions as is known for dynamic web pages. This allows for the content provided to be fully configurable by the end user. It allows for features such as blogs, forums, online shopping/eCommerce, membership sites, team collaboration, job boards, wiki's, and social media, to be hosted on the server. In contrast simple file servers will only allow for static web pages thus substantially limiting the user's ability to use and interact with the content provided.

Thus users who are in the mobile environment e.g., a ship, may access the content held on the server without access to the internet, and other users may also access the content held on the server over the internet.

Other aspects of the invention will become apparent from the appended claim set.

### BRIEF DESCRIPTION OF THE FIGURES

Embodiments of the invention are now described, by way of example only, with reference to the accompanying drawing in which:

FIG. 1 is a schematic representation of a portal server;

FIG. 2 is a flowchart of a process of the synchronisation of the content held portal server 10 to a cloud based server;

FIG. 3 is a flowchart which describes the process of the USB synchronisation as shown at step S104 in FIG. 2 in further detail; and

FIG. 4 is a flowchart of the process of the server emulating on online status to allow a user device to shut down a captive portal page.

### DETAILED DESCRIPTION OF AN EMBODIMENT

In order to overcome some of the problems associated with hotspots known in the prior art, in particular those which are found in areas with limited connectivity, there is provided a portal server which is designed to be used in situations where there is limited or no connectivity (such as cellular connectivity, 3 or 4G mobile telecommunication connectivity) to the internet. The invention provides a plug-in and play self contained portal to which local users can log-in with a computing device such as a laptop, smartphone, tablet computer etc., and access content stored on the server without access to the internet. The server provides a “captive portal” which allows the user to access to the content stored on the dynamic web server (thus providing a “walled garden” of content). The captive portal ensures that a user who connects to the portal server is presented with a server homepage which must first be accessed before the user to able to access the content stored in the walled garden. The content accessible by the user is stored on a web server contained within the portal. The portal does not typically provide the user with access to the internet or world wide web, but allows them to access the content stored on the internal web server. The term web server is used to describe a server which has http type capabilities as well as server side scripting (such as PHP and MySQL, and is therefore able to host websites with database back ends but does not typically allow access to the internet. In certain embodiments access to the internet is provided, for example when synchronising content or when connection to third party services are required, for example payment processing or fulfilment services e.g. Paypal®. In certain embodiments external users (i.e. those outside the connection range of the server) may access the content on the server over the internet in the known manner using the server's IP address.

The invention provides an integrated dynamic domain web server, network router with a captive portal capability, an access point which allows multiple users to access information stored on a dynamic server and a cellular connectivity point (such as 3 or 4G) to allow the dynamic web server to synchronise with an external or cloud server. The server does not provide the users with direct access to the internet, but provides the user access to content stored locally on the internal web server via a captive portal. Preferably, the server has limited access to the internet in order to synchronise data held on the server with the internet and, for example, to validate any e-commerce transactions. The invention therefore can be used, but not exclusively, in situations where there is limited connectivity to allow users to access content such as multimedia content. The present invention therefore has applications for use in aircraft, underground trains, cruise ships etc. It may also be used in areas where the service provider wishes to control what content a user can access, for example in a business environment, schools, prisons etc.

In further examples there are also included data servers and/or media servers. Web servers have specific functionality that is configured so that back end processing, including server side scripting, is possible, as is data capture and storage for later use. The captive portal ensures that a user who accesses the device is firstly presented with a specific homepage or welcome page. Preferably the welcome page contains terms of use as soon as the user connects to the Wi-Fi network. Once the user accepts the terms of use, the user is directed to the home page of the portal which is within the walled garden stored on the web server.

Therefore the invention provides a fully integrated wireless web server that offers full domain web server capabilities in a mobile environment, thus enabling dynamic web content to be accessed by personal mobile device users using their own built in browsers which are connected via the integrated wireless access point and Captive portal network router. As this is a full web domain server with a static IP assigned to the integrated cellular modem, it enables normal internet users to access the full web domain that may be hosted within a mobile environment.

The invention allows the server to be placed and used in a moving/mobile environment e.g. aircraft, bus, ship etc., and allow users to access and interact with dynamic web content using their own mobile devices (e.g. Smart Phone, PDA, iPads, Laptops), via the server. By allowing the user to interact with the content on the dynamic server, content is emulated in an online manner. Therefore the user is able to interact with dynamic web pages and dynamic web content as if they were online. The data collected on the internal database can later be synchronised with online databases when either Wi-Fi or cellular connectivity to the Internet is possible.

The integrated cellular connectivity with static IP allows external connections to access the domain hosted on the mobile server. The web server and router work together and control which data requests are allowed out to the internet and which incoming connections are allowed from the internet. The static IP address enables the server to have its own IP address and when connected to the internet, optionally allows general internet users to access the same content as offered to local (within Wi-Fi range) users. A key benefit is that the mobile server can be maintained/monitored remotely using VPN (Virtual Private Network) over the cellular connection (e.g. 3G or 4G).

The integrated unit can be installed in moving/mobile type environments where space is limited, and where installations of this nature would otherwise be complex to install requiring additional connections, separate power and power stabilisation systems, and separate configuration for each component. The integrated unit is designed to be used with power requirements suitable for different mobile installations.

The invention allows for such interactive capability as the dynamic web server is configured to enable dynamic back end server processing based on user interactive input. The dynamic server enables advanced server configuration to allow the use of server side scripting e.g. Apache (Web engine), MySql (Database), and PHP (Pre Hypertext Processing) as well as content management systems e.g Wordpress, Drupal and joomla etc. Therefore the dynamic web server provides the users and/or web site administrators to manage web sites and to access interactive, dynamically changing web sites without a connection to the internet.

In an embodiment, as the web domain server also has a static IP address external users i.e. those other of the range of the access point of the server, may access the content stored on the web server using known methods by polling the IP address of the server. Therefore, the invention in an embodiment allows access to content to other internet based users using known internet protocols.

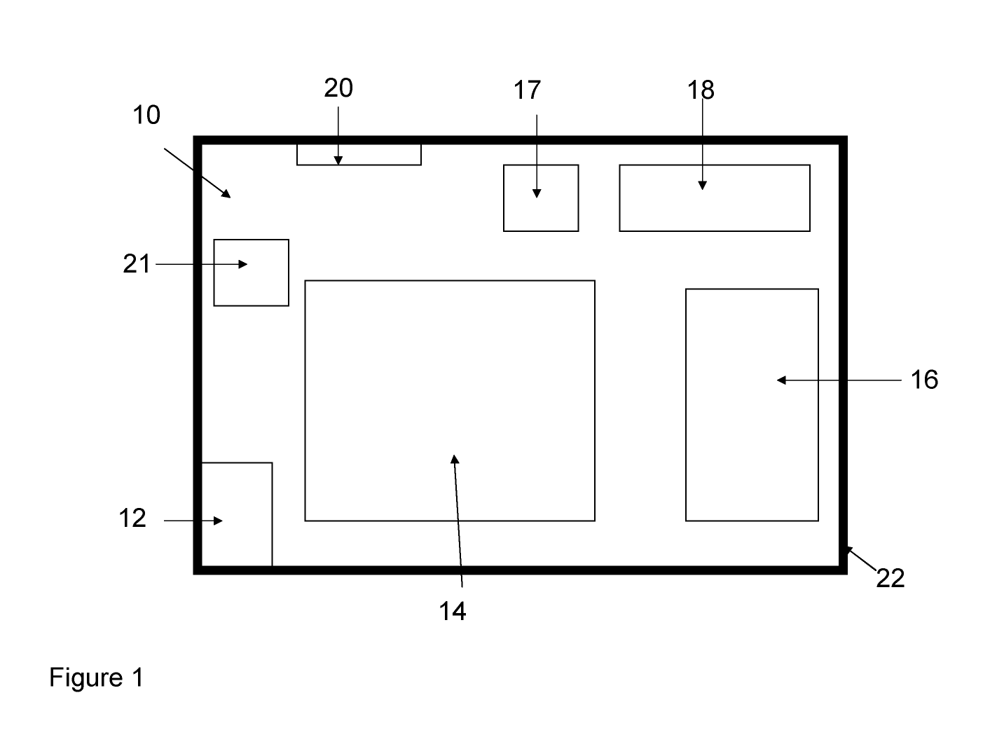

FIG. 1 shows a schematic representation of the integrated server, router and access point.

There is shown: a portal server 10; a portal server comprising a power supply 12; an internal web server 14; access point 16; a network captive portal router 17; a 3G or 4G connectivity port 18; a USB port 20; a Wi-Fi access point 21 and casing 22. In an example the connectivity port 18 is integrated internally to the server 10 i.e. it is integrated within the casing 22.

Therefore an aspect of the invention is the ability to provide full dynamic functionality in an integrated unit. The unit is therefore able to provide simple plug-in and play functionality allowing for rapid installation and updating in remote locations e.g. the fuselage of an airplane.

The portal server 10 is contained within the casing 22. The casing is a robust ruggedised casing which is designed to 1 U (rack unit) of a server rack in size. The portal server 10 comprises a power supply 12. The power supply is a known power supply configured to power the portal server 10. Also contained within the casing 22 is an internal web server 14. The internal web server 14 is a full active domain server which allows for dynamic and interactive web pages. The server therefore has the dynamic capability of a full server typically associated with an ISP or web hosting provider. This server runs APACHE and is configured to handle requests in server scripting language such as PHP and MYSQL. A router 16 is connected to the internal web server 14 allowing for users to access the internal web server 14 via the network captive portal router 17. The access point 16 in an example is a Wi-Fi access point, such as a Ubiquiti Bullet, and router board, such as a Microtik RB800. In an example, the router can connect up to 800 concurrent users. The router 16 therefore controls the access of external users (not shown) to content held on the internal web server 14. The Wi-Fi access point is a known commercially available access point, and is connected to the router in the known manner. There is also included within the casing 22 a 3G or 4G connectivity port 18. In an example the 3G/4G device is installed within the Portal server 10 as an integrated cellular device, and preferably is not connected to one of the USB connectivity ports 20. Optionally, the accessibility of the connectivity port 18 is disabled for the users and therefore the internet is not accessible to the users via the for router 16. The casing 22 therefore contains the integrated portal server, which comprises many of the components. In an example components such as the USB ports 20, server reset switch, wireless antennae, and master power switch (not shown) are preferably integrated as part of the casing. The outer casing in an example also includes 4 LAN ports and a port to connect a display device is required. Preferably, the portal server would be managed wirelessly using remote desktop or VPN.

The connectivity port 18 in an embodiment is a IP based cellular device connected by Ethernet or USB, though in other examples other types of connectivity ports may be used. The casing 22 also has further connectivity points such as a USB port 20 to allow a user, such as the server administrator, to connect external USB devices by the USB port 20.

In use, the portal server 10 can be installed in a known server rack (not shown) and powered via the integrated power supply 12. The data is stored on the fully functioning dynamic internal web server which has a solid state hard drive. 14.

The portal server 10 allows for the following functionality in the self contained unit: (1) a full web content management system (Web server with dynamic back end processing capabilities), which allows for the use of PHP server side scripted processes requiring SQL functionality and full interactivity; (2) network router capabilities with captive portal functionality enabling the user to access the content; (3) cellular connectivity to connect to the internet to allow for periodic updating and synchronisation of the dynamic content store upon the server; (4) Wireless Network Access through which wireless devices can connect to the integrated server and dynamic IP addresses issued to mobile devices by the captive portal router. This allows controlled access to web content to local users connected wirelessly, even when there is no internet connectivity. The captive portal router also controls the issue of cookies to manage how long a user can connect to the server before re authenticating.

The dynamic domain server is a mini computer with a full server side operating system installed, such as Linux, with an Apache, PHP, MySQL database server for dynamic back end processing initiated through user interaction. This enables full dynamic web content management systems to be used, and therefore enabling multiple dynamic plug-ins to be used to enable the user to experience the full dynamic web experience even when offline. This enables the users to interact with dynamic content such as shopping with credit card processing, blogs, forums etc. The dynamic content control also allows for control of multimedia (e.g. videos, movies, songs etc.) to be streamed to the end user without the user downloading the file permanently. This helps the server 10 provider to maintain control of the material which may be subject to copyright and digital media rights restrictions.

In an embodiment the server 10 comprises a full content management system, such as Wordpress, Drupal and Joomla, containing multimedia content such as videos, photos, documents, eBooks, music etc. and also the capability to host Blogs, Forums, eCommerce sites, Social Media and other web functionality requiring dynamic back end server processing. As the internal web server 14 is a dynamic web server, the server may also contain full dynamic websites which can run server scripting languages such as PHP and MYSQL Databases. Therefore, a user who accesses the portal server 10 via the network captive portal router 17 can fully experience the web pages stored on the web server 14 without any loss of end user experience. This is in contrast to a normal connectivity hotspot where only a cached version of a web page will be stored, therefore preventing the use of any dynamic scripted processes on the web server.

A further advantage is that due to the small size of the casing 22, being able to fit within 1 U of rack space, the portal server 10 provides a fully functioning domain server which is much smaller than typical servers that can be installed in mobile environments such as coaches, trains, and small aircraft. For the reasons described below, the server 10 also allows for a plug and play capability without the need for any specialist configuration of the server at the point of installation. This allows the content held on the internal web server 14 to be instantly viewed by any person who has connected via the integrated access point.

The internal web server 14 has a capacity of 500 gb (expandable) data storage, though in different amounts of data may be stored. This allows for the full content of one or more websites to be stored on the internal web server 14 including memory intensive data such as multimedia data e.g. films, photos etc. The hard drive storage is a solid state drive. The solid state hard drive is used to overcome issues arising from the use of the invention in a mobile/moving environment. For example vibrations of an aircraft or bus may be a significant factor if the portal is installed in such a location as they may corrupt the hard drive.

As the portal server 10 is designed to be installed in areas with limited or no internet connection (for example, a cruise ship), the ability to provide large amounts of content, typically requiring high bandwidth, within a walled garden is particularly beneficial.

As described below in further detail, the user connects to the wireless network, and is presented with a captive portal screen. Once the terms and conditions have been accepted the user is directed to the internal web server 14 via a web browser stored on the users device. The user is therefore able to “surf” the content stored on the internal web server 14 in the same manner as they would normally view world wide web content on the internet.

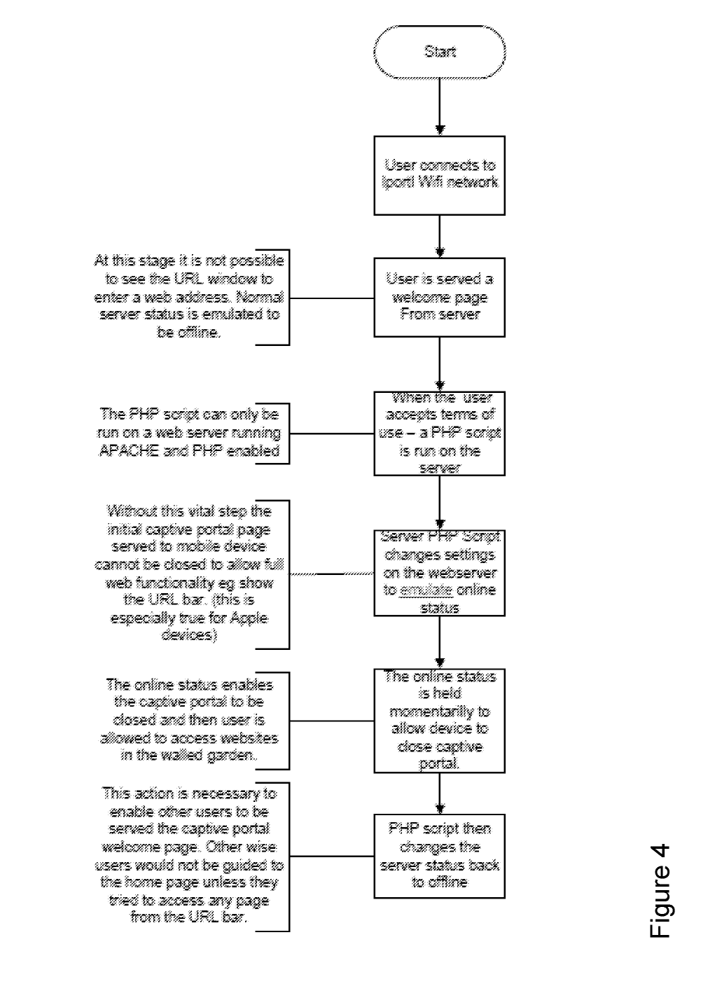

However, it is found that many consumer devices are unable to close the captive portal if there is no active connection to the internet. In order to overcome this limitation there is a provided a method as outlined with respect to FIG. 4.

An aspect of the invention is that as the unit is integrated and already provides the captive portal page and integrated network abilities it allows for simple Plug-in and Play capability. This is particularly useful on remote locations such as aircraft where it would not be expected that air crew would trouble shoot the different components of the system. The integrated unit can be installed in moving/mobile type environments where space is limited, and where installations of this nature would otherwise be complex to install requiring additional connections and separate power and power stabilisation systems.

The integrated server 10 is designed to be used with power requirements suitable for different mobile installations, e.g., on an aircraft, power requirements must be 110 v and 400 Hz. If each component was separately installed, each would need a separate power, wiring and configuration and certification for Aircraft use. Management and maintenance would also be more complex and costly.

The integrated cellular connectivity with static IP further allows external connections to access the domain hosted on the mobile server. The webserver and router work together control which data requests are allowed out to the internet and which incoming connections are allowed from the internet. The Static IP address enables the web domain server to have its own IP address linked to the web domain address, and when connected to the internet, optionally allows general internet users to access the same content as offered to local (within Wi-Fi range) users. Another benefit of the static IP address on the cellular connection is that a mobile server can be maintained/monitored remotely over the internet using secure VPN (Virtual Private Network) this is particularly useful when the server is located in an aircraft and its not practical to physically attend to the server for maintenance or trouble shooting.

A further aspect of the invention is that as the server is a full domain server with a static IP, internet users can access content on the mobile server in the normal fashion i.e. by accessing the content using the static IP address of the server.

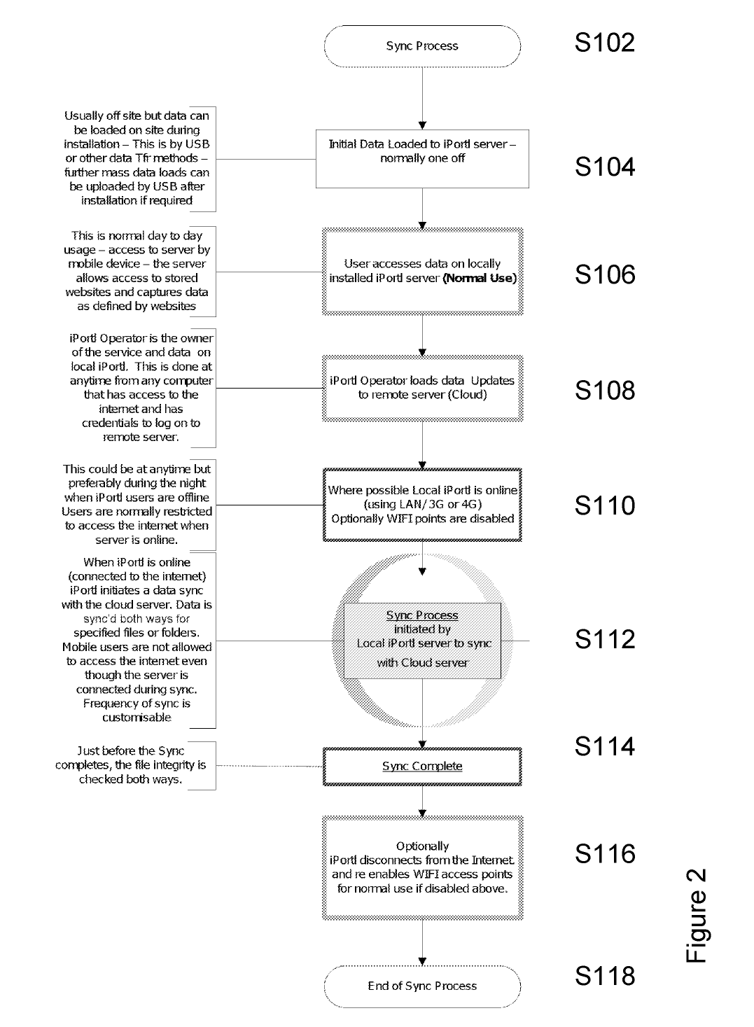

FIG. 2 shows a flowchart of a process of the synchronisation of the content held portal server 10 to a cloud based server.

Optionally, in normal use, the cellular data port, such as a 3G connectivity port, 18 is turned off, thus preventing access to the internet via the router 16. The connectivity port 18 may be turned off due to a lack of coverage in the area in which the portal server 10 is currently placed, or is kept off to ensure that only the content stored on the internal web server 14 may be accessed by the router. As the internal web domain server 14 is a dynamic web server enabling the users to access and upload/download content, the data stored on the internal web server 14 may need to be updated. Furthermore when the data stored on the internal web server 14 is, say for example, a transaction based website (such as an online shopping website) then orders submitted to the website can be uploaded to the internet in order for them to be fulfilled. In other embodiments the connectivity port 18 remains on during normal use but users are provided with limited or no access to the connectivity port and therefore are limited to accessing the content on the web server 14. Super users, such as administrators, may be given further access to the connectivity port.

Accordingly, there is provided a method of synchronising the portal server/web domain server 10, and in particular the content held on the internal web server 14 with a cloud based server on the internet, preferably by the connectivity port 18 or LAN where available.

At step S102 the synchronisation process begins. At step S104 the initial loading of the data on to the portal server 10 occurs. This usually occurs offsite where the data is added to the internal web server 14, however this may also occur during onsite installation via means of the USB ports 20, or any other form of data transfer method. For example, the data may be transferred wirelessly via the router 16, or through a wired connection (not shown). The initial data loading process at step S104 is therefore typically a one-off process, however data may be uploaded to the internal web server 14 via the USB ports 20 as and when required. For example, this may occur when large amounts of content are to be installed onto the internal web server 14, for example when an entirely new website or multimedia content (such as films) is being installed into the system and it would be too slow to perform over a 3G connection.

At step S106 one or more users accesses the data held on the internal web server 14 on the portal server 10 via the router in the normal manner (described below). The internal web server 14 therefore contains the stored websites, and records any relevant data inputted to the websites by the user. Furthermore, the portal server 10 provides the user with the ability to upload multimedia content and this is also stored on the memory associated with the internal web server 14. Therefore, the data on the internal web server 14 is constantly updated during normal use, and in order to ensure a better user experience, it is desirable to ensure that the data is updated. As the portal server 10 may be installed in static locations (such as shops, cinemas etc) the updating at step S108 may occur on a regular basis as the portal server 10 is likely to be always able to connect to the internet. Typically this would occur when the server is not in use, for example during the night. In examples where the web domain server 10 is used on aircraft where cellular connectivity is not allowed/possible during flight the updating step at S108 will only occur during periods where connectivity is allowed such as when the aircraft is grounded. In further examples where the 3G/4G connectivity port is left on the synchronisation process may occur at any time.

In the embodiments where the portal server 10 is installed on a moving location (such as a ship, bus, train etc) then the synchronisation process may be performed on an ad-hoc basis as and when the portal server 10 has connectivity to the internet. In an example, a 3G connectivity port 18 is used to synchronise the data, and accordingly, step S108 only occurs as and when there is a 3G signal. Similarly, in further embodiments where the connectivity port is a 2.5G, 4G etc port then the synchronisation at step S108 will only occur when there is such connectivity. Once connectivity has been established, the portal server 10 uploads data updates to a remote server such as a cloud server.

In an embodiment, in order to ensure that users are not able to access web content or data other than those stored on the internal web server 14 when the synchronisation process begins the Wi-Fi access points via the router 16 are disabled at step S110. In order to minimise user disruption, the synchronisation process therefore occurs at times of minimum or no use, for example during the night. At step S110, therefore the portal server 10 is connected to the internet via the connectivity port 18 and the router 16 has been disabled. In further embodiments the server 14 is able to synchronise with the external remote server at the same time as allowing user connectivity. For system security reasons it is preferred to restrict access to the server 14 during internet based synchronisation.

Once the portal server 10 is online, a data synchronisation process with the cloud server is begun at step S112. The data synchronisation process occurs as a two way process allowing the internal web server 14 to update data stored on the server, as well as download additional content to be stored on the web server 14. Preferably, a file integrity check is performed and the synchronisation process is completed at step S114.

At step S116 the connectivity from the 3G connectivity port 18 is disabled and the wireless router 16 is re-enabled allowing users to access the portal server in the normal manner. At step S118 the synchronisation process ends.

To increase the security of the system, in a preferred example, the synchronisation is initiated by portal server 10. This eliminates the possibility of unauthorised access to the server since portal server 10 only connects to a predetermined server in the cloud. Login credentials are stored on the server, and this is used by the server 10 to synchronise with the external cloud server.

As well as providing a 3G, or similar, functionality to synchronise the data, the data on the internal web server 14 may be synchronised using a USB driver/stick and/or LAN connection (not shown).

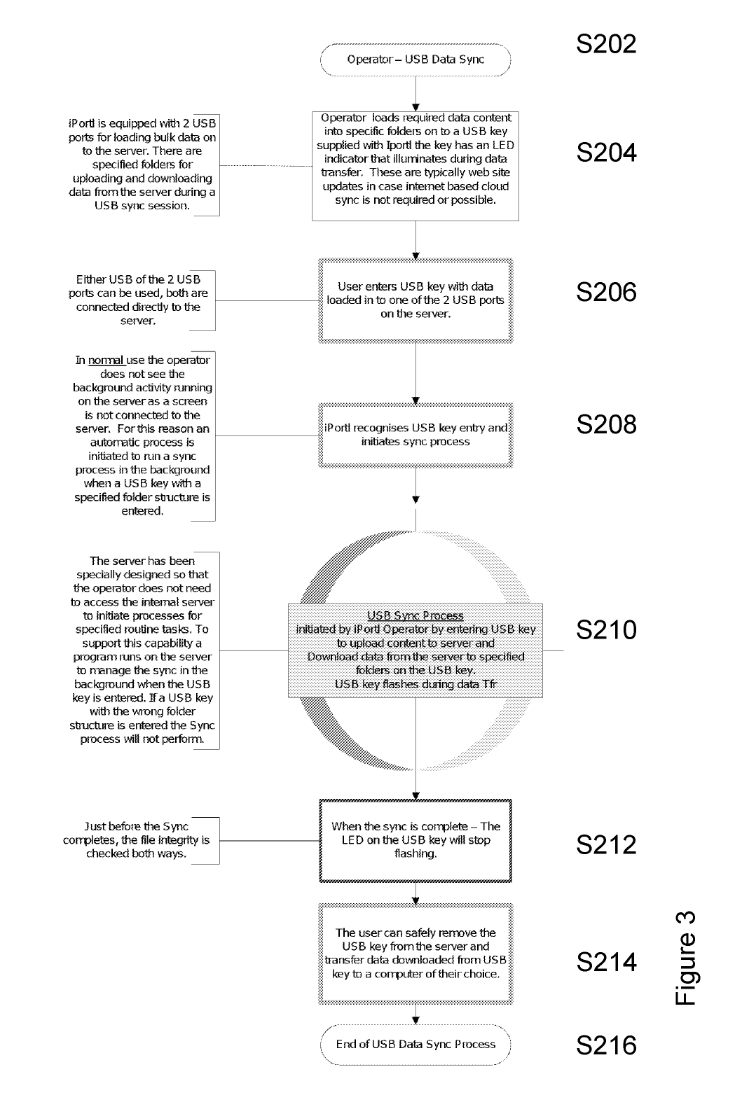

FIG. 3 describes the process of the USB synchronisation as shown at step S104 in FIG. 2 in further detail.

In order to preserve the integrity of the portal server 10, it is important to ensure that the content uploaded onto the internal web server 14 is trusted content and that third parties cannot upload content via the USB connection ports 20 without permission from the server manager. To ensure that only content is uploaded by trusted users the portal server 10 specifies a folder structure for uploading and downloading of data from the server 14 during a USB synchronisation assessment. In further examples, other forms of authentication may be used.

At step S204, the operator loads the desired data content (for example, updated pages on a website, multimedia content, an entirely new website to be stored on the internal web server 14) into the specific folders on a USB key. Therefore, the uploading via the USB allows for the updating of content on the internal web server 14 in the event that connection to the internet via the cloud synchronisation process as described in FIG. 2 is not possible.

At step S206 the user inserts the USB key into the USB port 20.

As the server 10 is designed to be used without a display, the authentication process is performed on the USB key/stick. The specific folder structure which is entered on the USB key, which matches the specific folder structure required to upload and download data from the server, is used as the authentication mechanism at step S208. If a USB key with the incorrect folder structure is inserted into the USB port 20, the synchronisation process is not performed.

At step S210 the key is found to have the valid folder structure and the synchronisation process of the data held on the USB key begins. At step S212 a file integrity check is performed both ways to ensure the synchronisation process is complete and the server emits an audio output such as a beep to notify the operator that the synchronisation process is complete. In further examples a visual output such as an LED on the USB key may be used to indicate to the operator that synchronisation is complete. At step S214 the user removes the USB key from the USB port 20 and the data has successfully been uploaded to the internal web server 14. At step S216 the data synchronisation process is complete.

Advantageously, this allows for the simple uploading and downloading synchronisation of data on the internal web server 14. As the authentication of the data occurs via the USB stick (by the checking of the specific folder structure) then this allows for a simple “plugin” synchronisation method whereby a server manager with little experience of data servers can update the data via the USB stick.

Therefore, the portal server 10 provides a gateway for a user to access data held on the internal web server 14. Therefore, the server may be seen as providing a portable hotspot system in which the user is able to access the data held on the internal web server 14 which is kept up to date via the synchronisation method described above. Whilst the present invention does not allow access to the full worldwide web, the data and content stored on the internal web server 14 provides the user accessing the server with a “walled garden” through which they can navigate and view the information and upload information as necessary. As full access is not normally provided to the worldwide web, the captive portal ensures that when the user accesses the portal server 10 they are presented with the homescreen without having to know the address of the homescreen. Preferably the user accepts the terms and conditions and is directed to another screen form which content which is available on the web server 14 is accessed. Therefore, users who log onto the portal server 10 are limited to the data which they can view. In many circumstances, the limited data available to the user is indeed desirable in order to maintain the integrity of the system (i.e. by preventing users from accessing websites which may contain viruses etc, or websites which may contain illegal or obscene content).

In further examples, it may be desirable to only allow users to access only certain websites for business reasons. For example, if the server is installed within a business, then it may be desirable to allow users to access content related to the business but to also prevent the user from accessing content related to competitors.

In use, the portal server 10 is switched on and the router 16 is switched on and transmits a Wi-Fi signal identifying itself as a Wi-FI network to which users may log in. As the server is integrated, and enables the plug-in and play type functionality the powering up of the portal server 10 results in all components of the server 10 being powered up and initialised. This enables the invention to be installed and users are able to use the invention instantly.

The router 16 serves the IP address and pages from the web server via the captive portal. The captive portal runs on the router and user device (where supported by device). A user can connect to the Wi-Fi network in the known manner. If necessary, the user may be required to enter a password. The user is then authenticated in the normal manner.

Upon opening a web browser to view a website stored on the internal web server the user is presented with a captive portal homepage displaying the terms and conditions/content which is viewable to the user as stored on the internal web server 14. If the user tries to access websites which are not stored on the internal web server 14 they will also be presented with the server homepage.

Preferably, there is a one off requirement for every browser session to accept the terms and conditions presented on the web page. This also allows for a cookie session to be initiated. The cookie session can be set to expire after a predefined period, such as one hour, as is known in the art.

The user is then able to access the full functionality of the internal web server and view content, download/upload content, utilise the full dynamic capabilities of the web server. Therefore, the server provides a full and active browsing session for the user as found on Internet hosted servers.

A further advantage of the server 10 is that it generates its own Wi-Fi network and captive portal to redirect any connected users to specified internal web servers home page and content. As the server 10 has a router/access point facility the Access Point can automatically link with other similar or identically configured access points within range to extend the overall range of the wireless network available for the servers. The joined access point would therefore have the same server set identifier (SSID). Furthermore, content stored on each individual server may be different and preferably if the access points share the same access point SSID they would be considered as part of the same network with an extended Wi-Fi range

Such a relay of servers has further benefits in situations where the servers are installed in areas where there may be large amounts of people and/or enterprises present. For example, the servers could be installed within a shopping centre with individual shops having their own portal server 10 and shop specific content stored the internal web server 14. In further examples a single server is used which has multiple automatically linking access points to extend the effective range of the server. Furthermore, by modifying the homepage to which the user must log onto the user can be presented with messages and/or advertising in order to increase the users' experience.

A further advantage is that as connectivity for mobile users is only to the internal web server 14 normal band width limitations associated with connecting large amounts of people to the internet is successfully overcome.

A further advantage is that the content can be synchronised by the USB synchronisation method which as it is authenticated using the file structure stored on the USB would allow for a non-technical person to update the content in a simple manner. Scripts are initiated on the server 10 to perform the synchronisation when an authenticated USB key, with a valid file structure is entered.

Further authentication methods for the USB stick may be used. For example, the USB stick may be imprinted with a digital key or image which is only known to the server 10 and is used to authenticate the USB stick.

Known captive portals only function when access to the internet is available. In order to overcome the limitation the server 10 must emulate to a client device connected to the portal server 10 an “online” status in order for the captive portal to function on the connected client devices. This functionality allows the user to close the captive portal (once authenticated/terms and conditions have been accepted) to provide full functionality of the client device's web browser including showing the URL screen in the browser.

When a device which does not support a captive portal facility accesses the server 10 the user of the device is presented with the server homepage when they connect to the wireless network and request any web page.

FIG. 4 shows the process of the portal server 10 emulating the online status of the server. By online status it is meant that the server has access to the worldwide web or internet. This process enables devices to connect to the portal server 10 and remain connected even when no connection to the internet is possible. In many consumer devices if the device is unable to connect to the worldwide web or internet the captive portal process will fail.

There is shown the process of the portal server 10 emulating an online status. The process stops at step S402, and at step S404 the user connects to the portal server 10 using the Wi-Fi network in a known manner. The user connects to the portal server 10 with a user device (for example a smart phone device, a tablet computer, a laptop computer etc.) which has web browsing capability.

At step S406 the user has connected to the portal server 10 and is presented with a captive portal on their user device. The user is presented with the captive portal in the form of a welcome page from the server at step S406. The welcome page from the server presents to the user via the user device, an authentication system which preferably contains the terms and conditions which the user must accept in order to utilise the portal server. The portal server status is emulated to be in an offline mode.

At step S408 the user accepts the terms and conditions for use of the portal server 10 resulting in a PHP script being executed on the server. The internal web server 14 is a dynamic web server which is enabled to execute server side scripting languages such as PHP.

As step S410 the server side script changes the setting on the web server (which by default are emulated to be in an offline status) to emulate an online status. This step ensures that the initial captive portal page can be closed (for example upon acceptance of the terms and conditions) and allow the user to access full web browsing functionality via their web browsing application. As the online status is only required to allow the user device to close the captive portal, at step S412 the online status is only temporarily held until such time that the user has closed the captive portal and is able to access the websites held on the internal web server 14.

At step S414 the PHP script changes the server status back to the offline status. This action is necessary to enable other users (of which there can be multiple other users) to access the captive portal home page. If the server status is not changed to the offline status at S414, the user would not be guided to the home page resulting in a less satisfactory user experience.

In an example, the server 10 may be installed in an inaccessible, or not easily accessible location (such as an aircraft's avionics bay, a bulkhead of a ship etc.). To perform maintenance on the server 10 in such locations, in an example there is provided the facility for administrators to wirelessly access the internal server. A Port with a static IP (which is only known to the system administrator(s)) is enabled on the router. The administrator uses known remote desktop or VNC software to be authenticated and to access the server with a user name and password. Once connected the administrator is able to view screens on the server as if they were connected using a keyboard and display unit. The wireless login therefore negates the need for a display on the portal server 10.

Therefore, the administrator access is controlled on two levels, firstly requiring the administrator to login via the static IP using VNC, and preferably requiring a further separate login to access the dynamic web server. Therefore, in an example, content can only be controlled by those with administrator privileges thereby reducing the risk of malicious content being present on the server.

The integral server hosting dynamic websites uses full a content management system. Users and operators can benefit from data collected via e.g. offline, Blogs, questionnaires, Forums, Membership and Shopping sites, Social Media. As the portal server 10 features cellular connectivity with a static IP, this enables normal internet users to access the integrated web domain by entering a normal web address as the IP address can be linked to an internet domain address and linked to the mobile domain server.

1-21. (canceled)

22. An integrated server access point for enabling access to web content without an Internet connection comprising:
a casing containing the integrated components of a:
an access point configured to allow a first user device to access the web content;
an integrated dynamic server configured to store the web content to be accessed by the first user, wherein the integrated dynamic server is enabled to perform server side scripting;
an Internet connectivity point, in the form of a cellular connection, configured to access the Internet;
a connection router enabled to present a captive portal page when the first user device accesses the integrated server access point, the router further having a port with a static IP configured to enable remote administrator access to the server;
wherein the integrated server access point is configured to enable access to web content by the user device without requiring a connection to the Internet at the time the user device accesses the content; and is further configured to intermittently synchronise some or all of the content of integrated dynamic server with an external web server.

23. The integrated server access point of claim 22 wherein the user device is prevented from accessing the Internet via the Internet connectivity point.

24. The integrated server access point of claim 22 wherein the data access point further comprises a first USB slot to allow data to be uploaded and/or downloaded to and from the integrated dynamic server.

25. The integrated server access point of claim 24 wherein the integrated server authenticates a USB driver inserted into the USB slot before uploading and/or downloading data to and from the USB driver to the integrated dynamic server.

26. The integrated server access point of claim 25 wherein the authentication of the USB driver occurs by comparing the file structure of files held on the USB driver with a predefined file structure.

27. The integrated server access point of claim 22 wherein the integrated dynamic server is configured to emulate an online status when the captive portal page is presented on the first user device.

28. The integrated server access point of claim 27 wherein the integrated dynamic server is configured to emulate an offline status at all other times.

29. The integrated server access point of claim 22 wherein the emulated status of integrated dynamic server is changed via a PHP script.

30. The integrated server access point of claim 22 wherein the captive portal page comprises the terms and conditions of use of the integrated server access point which the user must accepted before accessing content held on the integrated dynamic server.

31. The integrated server access point of claim 22 wherein the integrated dynamic server synchronises with the external server at a predetermined time.

32. The integrated server access point of claim 22 wherein the integrated dynamic server synchronises with the external server during periods of low user activity.

33. The integrated server access point of claim 22 wherein the access Point is disabled when the integrated dynamic server synchronises with the external server thereby preventing a user from accessing the integrated server access point.

34. The integrated server access point of claim 22 wherein the integrated server access point further comprises one or more of a server reset switch; wireless antenna; master power switch; an Ethernet LAN port; display port; and one or more further USB ports integrated as part of the casing.

35. The integrated server access point of claim 22 wherein the casing is ruggedised casing.

36. The integrated server access point of claim 22 wherein the dynamic server has a capacity of 1 TB or more.

37. The integrated server access point of claim 22 wherein the casing is one rack unit in size.
